(19) United States
(12) Patent Application Publication
(10) Pub. No.: US 2010/0185667 A1
(43) Pub. Date: Jul. 22, 2010

(54) System and method appending internet command functions

(75) Inventor: David Joseph O'Hanlon, Miller Place, NY (US)

Correspondence Address: David Joseph O'Hanlon, 466 Miller Place Road, Miller Place, NY, 11764, US

(73) Assignee: David Joseph O'Hanlon, Miller Place, NY (US)

(21) Appl. No.: 12/459,705

(22) Filed: Jul. 7, 2009

Related U.S. Application Data
(63) Continuation-in-part of application No. 12/352,602, filed on Jan. 12, 2009.

(51) Int. Cl. G06F 3/14; G06F 15/16; G06F 17/30

(52) U.S. Cl. 707/770; 715/205; 709/206; 707/E17.009; 707/E17.017

(57) ABSTRACT

A system and method of software database tracking design encompasses user, commercial user, professional and novice researcher usage of the internet on database systems located locally on hard-drives or remotely on servers through internet protocol design computers and storage systems alike IP telephony, mobile phones, mobile system storage devices and average home and laptop computers via software installation or as alternate service providers to emulate small as well as large command demand URL files upon objects, through menus, or display directly on a location on a website to dedicate to the user's need and demand for a high-grade interoperability of usage of tracking their movements on the internet both as point to point landing pages including objects as precisely offering step by step user's usage in a functioning internet environment including some cases of expertly delivering advertisements.

### RELATED APPLICATIONS

This application is a continuation in part (CIP). It is a CIP claiming reference and priority date status to application Ser. No. 12/352,602, which was filed on Jan. 12, 2009.

### FIELD OF THE INVENTION

The present invention relates to the field of an internet research application and content provided advertising.

### BACKGROUND OF THE INVENTION

All internet consumers and commercial researchers access millions of websites and password access pages every day to learn more about the world around them and to shop, see videos, make arrangements, reservations, and share in single URL format with their friends and family through email to sometimes make decisions based on these snippets of information while also seeing and using targeted advertising sent to one another in this current format.

First, the user accesses the internet via their service provider or installed desktop toolbar or the like and has multiple possibilities such as to open email, banking, looking at travel destinations, car purchase information, and then making their decision based on going backward and forward on these pages or saving them in history to gain the depth of the information previously seen. The user sometimes shares with co-workers, family, and friends, the different ideas of price, locations, and information leading them to transfer URLs to another person via email or instant message or looking in their own saved history to go over the principle of their desire for the use of the internet. Sometimes, forgetting where something was seen on the internet is common.

Second, the user has no control over adding, editing, and deleting, automatic or usage internet command files, menus, and objects displaying URL trails of interest.

Third, the user has no useful way to connect their interests in a format to share with others. They can't connect what they have seen and provide it to others. For example, the medical information gathered from the internet for a sick family member could be shared, edited, and added to by others in a single family. They may need flowers and the fully-developed database calculates from keywords to deliver specific advertisements for their need.

Related art is determinant upon a search by the examiner.

### OBJECTS OF THE INVENTION

It is therefore an object of the present invention to be useful to various person types, such as, researcher, homemaker, and business entities, having easy use of the internet environment access tools.

Another object of the present invention is to provide an economically feasible manufacturing cost.

A further object of the present invention is to provide a useful database tracking system for someone to do research for themselves and connect the usage pattern to allow for easy access, editing, adding, deleting, sharing, and providing the same access to others of the initial trail of research.

It is also an object of the present invention to provide a unique database to make calculations based upon the user of such a database tracking system while offered automatically in conjunction with selected user's use or subscribed upon their action to utilize the system as to expertly calculate their desire based on usage and calculations for information such as advertisements, previously visited websites, saved websites, being dependent upon database created expert delivery as an accurately updating database research tool to cast, continuously calculate, and perfect advertisements and tools to the user upon “objects” and within content pages.

A still further object of the present invention is to provide an acceptable ease of use from hardware, such as, producing URL files via wireless or physical connection to a computer software interface, or information located thereon said hardware, to interface the internet through the use of keyboard keystrokes and editing, adding, and deleting, having internet command functions, recordation beginning, or other conjunctive property to the principals said herein, made possible by physical forms upon the computer peripheral, such as, but not limited to, keyboard keys or computer mice buttons. This is either set up alternately between software interfaces and the said peripheral or done solo.

### SUMMARY OF THE INVENTION

In keeping with these objects and others which may become apparent, the present invention includes a business implemented method to assist users and commercial enterprises in researching on the internet by recording the user's usage in direct point to point and step by step recorded pathways by adding to the common internet the necessary “objects” to inform the user of both desire and position therein. For example, a user performs searches and commands on the internet, and visits websites related to cerebral palsy. The desire, a common marketing term, may be medical devices, medicine or medical websites, as displayed advertisements. The position would be a relative number, letter, or image, showing where you are in terms of the research. In a single case the adorning of position may be unnecessary.

The database tracking system method is both replete with information gathering as well as calculating as databases are intended to be. For example, use of common advertising systems yield best case scenarios in calculating key-words and spelling out where and when ads are displayed on the internet. However, they are not limited to only key-words going well beyond as to include timing and geography.

In the present invention, the business implemented method, has to be focused on only some of the terms, where, however, the usage of, “such as,” and, “but not limited to,” are used to only scratch the surface of the expert design, and therefore replete as mentioned previously, having this broad spectrum.

In one embodiment, the analysis adds commercial user with ratios of advertising a brand to the consumer. For example, this would allow for three company advertisement logos to be tested starting at different sizes of impressions and to then narrow to the best advertising for user's usage. And this ratio testing is only one to name out of the few already discussed. It is better said as multivariate testing. Any number of variables may be applied.

In the preferred embodiment, a flow diagram, there may be at least one automatic or personally created destination for the user. For example, an automatic development of a recorded URL in an organized database, may suggest the user has saved recent favorite websites. A created or predetermined image can allow them access from a webpage thumbnail or produced list thereon as content in content pages where the user's use begins online. The preferred embodiment also relates the simple point A to point L firing of URLs to the final landing page as well as a step by step configuration.

A system and method of software database tracking design encompasses user, commercial user, professional and novice researcher usage of the internet on database systems located locally on hard-drives or remotely on servers through internet protocol design computers and storage systems alike IP telephony, mobile phones, mobile system storage devices and average home and laptop computers via software installation or as alternate service providers to emulate small as well as large command demand URL files. A newly defined computer software system and method is created to allow a beneficial access to the internet, interesting people and businesses alike, in content found on the internet, including the content dissemination to multiple party users, advertisers, and information gatherers, for education or monetary gain. A practical use of internet commands recorded to emulate a quick and final destination for the computer user.

The computer user selects commands to access the internet after they subscribe or are freely provided to use the computer software program. They begin with the computer software program interface that will begin tracking their movements on the internet. As each progressive step of any type, albeit, but not limited to, search boxes, touch screen, voice command, hyper-linking, and secure password and login names, for example, are utilized, the result is the recordation of the path used to find the final destination, resulting in a single image, that may be named by the participant, to cut down on the flow of steps to reach said internet destination.

The ability to complete at least one dual command and actuation function is created. This would allow a user from going to “Internet Command A” first and then to “Internet Command B.” The result of the path recordation would be to go to “Internet Command B” without the use of landing “Internet Command A” first. This is done using the coding of an image on a desktop, aptly named by the consumer computer user. It may also be at least one image is placed in a separate format somewhere on the computer, within the software interface or on the first locale of visiting a webpage where they are stored or however a place, readily available, to still operate said computer software system.

This practical use extends to sequential images as well. The computer user may choose from “Internet Command A” and go to “Internet Command B” and sequentially or by-stepping to “Internet Command X” one at a time until the final destination is achieved or the computer user is finished at any variable in between. Known as computer toolbar interfaces is one option, but not limited to, displaying each sequential image and the number of steps it will take to reach the destination by a computer user implementing a trail through the computer user interface.

The computer user or commercial computer user may send or link through a network with friends, software community members, or within businesses the trails one creates. The commercial computer user can network, but is not limited to, providing through at least one database, a display of trails, including multiple choices, such as, trail variations or impressions of differently defined trails, to select the best content created for use by the consumer.

The content created by the commercial computer user, includes, but is not limited to, the advertisement of routing to consumers through a network, trails, defined by the computer software system and method. Images for each computer may be interfaced with choices of personally designed or predetermined images acceptable to the consumer or commercial computer user. The computer software system and method can also be used for a set of predesigned website pages or created content utilizing the method to provide, but not limited to, tutorials, internet research workflow, or the use for presentations.

A more radically simple design may be fixed type or hyperlink color, but is not limited to, the boxing and coloration for visibility by the consumer of the selection to satisfy following trails on the internet. It is also beneficial to enable cookie conversion, but is not limited to this parameter, for creating trails on the internet.

The use of varying the actuation or more simply, mouse-clicks, go to commands, voice control, touch screen, or hyper-linking of the computer commands alternately, by the selection of a sequential image having said actuation or personally on the content, by the consumer or commercial computer user may also be beneficial.

More significantly, hyperlinked advertising indicia is presented on each image or one at a time on each sequentially presented image or becomes dependent on the internet alteration said image transforms thereon, but is not limited to, a toolbar or different interface for following trail steps. This includes the allowance for varied or fixed hyperlinked advertising for multiple exposures as each step of a trail is taken. The image may also include a type box for internet commands, such as, but is not limited to, internet searches, partial or end-result passwords and log-in names, or streaming current information. The trail image is also available to drag to the desktop to disseminate to other users through email and still operates thereby said computer software system method or said computer software system method encoded therein, rather than collecting only in the said computer software interface or storage place.

The computer software has a number of respective mutually exclusive and at least some inclusive concepts part of the time as follows:

A computer software system, having command method comprising multiple internet commands appended thereto, wherein the following instructions are utilized:

A computer user selects first internet command function, accessing the internet;

Said computer user selects the second internet hyper-linking command function, continuing to access internet further, said command function, appending command function I, logging pathway I and logging and actuating command thereon dependent function II, resulting dual command function, generated by computer software system;

Said computer user selects another command, creating triple command and further commands or stops;

Wherein any number said internet command functions, including, but not limited to, hyper-linking, typed instructions, and go-to page commands, are recorded, through computer software system code and display therein said computer software system image interface, including, but not limited to, desktop or webpage said computer software system code image record result;

The computer software system wherein at least on dual internet command function is created;

The computer software system image interface wherein the recorded coded images are computer user organized categorically, edited, added, or deleted;

The computer software system wherein the computer user begins online;

The computer software system wherein internet access is direct using said computer software system website search type-box directly affecting access point;

The computer software system wherein said command function, includes, but not limited to, automated fill log-in and password commands;

The computer software system wherein said command functions are protected, including, but not limited to, secure sockets layer system;

The computer software system wherein at least one graphic tool, including but not limited to, a text-tool is used to adorn a predetermined coded image;

The computer software system wherein a predetermined or creative coded image constitutes user logged pathway and actuating commands;

A computer software system, having command method comprising multiple internet commands appended thereto, wherein the following instructions are utilized:

A commercial computer user selects first internet command function, accessing the internet;

Said commercial computer user selects the second internet hyper-linking command function, continuing to access internet further, said command function, appending command function I, logging pathway I, and logging and actuating command thereon dependent function II, resulting dual command function, generated by computer software system;

Said commercial computer user selects another command, creating triple command and further commands or stops; a generated coded image predetermined or created becomes database directed;

Said database displays named command function wherein said computer user chooses possible selection;

Wherein said computer software system displays, including, but not limited to, said database directly through said computer software system image interface through placing database data back through the internet said computer user personal location or accessible webpage;

The computer software system wherein at least one database record is created;

The computer software system wherein at least one recorded database entry results said computer user selection;

The computer software system wherein at least one recorded database entry results said computer user selection;

The computer software system wherein said database provides advertising categories;

The computer software system wherein said database provides said personal location or said accessible webpage impressions said commercial computer user created said coded image predetermined or created;

The computer software system wherein said database ranks first said commercial computer user relevancy said computer user selected created said coded image predetermined or created said result higher internet traffic;

The computer software system wherein said database allows one commercial user multiple variant impressions coding and said image;

The computer software system wherein said database allows one commercial user multiple variant impressions images and said coding;

The computer software system wherein said database records per impressions, actuations, said computer user so chooses;

A computer software system, having command method comprising multiple internet commands appended thereto, wherein the following instructions are utilized:

A commercial or consumer computer user selects first internet command function, accessing the internet;

Said commercial or consumer computer user selects the second internet hyper-linking command function, said command function, appending command function I, logging pathway I, and logging and actuating command thereon dependent function II, resulting dual command function, generated by computer software system;

Said commercial or consumer computer user selects another command, creating triple command and further commands or stops;

A generated coded set of sequential images predetermined or created becomes said consumer computer user accessible or said commercial computer user database directed;

Said consumer user said accessible said sequential images display said command functions in unitary sequence format wherein said computer user chooses step 1 said sequential image displaying step 2 upon selection said step 1;

Or said commercial computer user said database directed said sequential images display said command functions in unitary sequence format wherein said commercial computer user sets onto said database network;

Wherein said computer software system, including, but not limited to, provide said accessible said unitary or said sequential image said consumer user access within said computer interface, including, but not limited to, desktop or webpage said computer software system code image record result or said commercial computer said database directly through said computer software system image interface through placing sequential image data therein through internet said commercial computer user said consumer computer user personal locations, such as objects, but not limited to, toolbars, or browsers or within accessible webpage via said network, including, but not limited to, desktop or webpage said computer software system code image record result, including, not requiring, but not limited to, at least one advertising indicia;

The computer software system wherein at least one dual internet command function said sequential image is created, including, but not limited to, utilizing hyper-linking, typed instructions, go-to page commands, touch screen and voice control for continuing to access internet further display objects;

The computer software system wherein networks or email are used sharing images or said sequential images;

The computer software system wherein an image or sequential image is predetermined or personally created;

The computer software system wherein said database uses multiple trail images variations ranking;

The computer software system wherein said database can be searched, but not limited to, keywords wherein said keywords are within said content or title another trail;

The computer software system wherein a separate system graphic interface, including, but not limited to, computer system interface tool bars, desktop icons, website browsers, or most recent graphics displayed in any format, are used to begin tracking, also displaying upon said image or said sequential image, within said separate system graphic interface, step values, in part or whole, ability to toggle forward or backward, or said images or said sequential images, having said value or said values, wherein displayed separately, within said separate system graphic interface, are the pertaining number of steps taken or said ability to toggle forward or backward, including, advertising indicia thereon said separate system graphic interface;

The computer software system wherein pre-designed website pages or computer interface images provide trail destinations containing at least one common command thereto, pertaining, but not limited to, tutorials, research workflows or presentations;

The computer software system wherein type or hyperlink color, but not limited to, colored boxing these, are used to follow destined trails said computer user providing at least one said actuation command either alternately between said image or said sequential image or utilizing completely;

The computer software system wherein computer cookie information determines destination through actuation command instructions upon stored said cookie information said computer software system conversion;

The computer software system wherein at least one image or at least one said sequential image having at least one adorned hyper-link advertising indicia;

The computer software system wherein at least one image or said at least one sequential image derives at least one related separate graphic interface, such as, but not limited to, internet and desktop toolbars, menus, or open interfaces, transforming, during a transition from the desktop to the internet, wherein at least one image or said at least one sequential image or their predecessor, at least one related separate graphic interface, advertise hyper-linked indicia;

The computer software system wherein at least one image, at least one said sequential image, or at least one related separate graphic interface, such as, but not limited to, internet and desktop toolbars, menus, or open interfaces has adorned hyper-link advertising indicia, wherein said advertising indicia is varied or has fixed multiple advertising exposures during each trail step;

The computer software system wherein at least one image or said at least one sequential image, includes, at least one type box, but is not limited to, internet searches, partial trail or end-result trail passwords and log-in name actuations, or streaming current advertising indicia;

The computer software system wherein multivariate database testing said at least one advertising indicia wherein desktop or separate graphic system interface displays said at least one advertising indicia, resolving economic demand, including but not limited to, multiple advertising formats;

The computer software system wherein at least one image or at least one sequential image is layered or said layer said image is encoded;

The computer software system wherein at least one image or said at least one sequential image potential path are selected having at least one criteria value within an organized database interface wherein at least one internet transfer said path delivers website expert component created advertising indicia therein said organized database interface wherein said advertising indicia appear thereon website content pages utilizing predetermined potential path embedded website code integrated by an expert owner said website;

A computer software system, having method comprising at least one internet command appended thereto record, wherein the following instructions are utilized:

An automated at least one criteria value within an organized database interface sets data tracking system selection before, during, or after computer user internet use;

The computer user selects at least one website;

A predetermined or personally created record results;

Wherein at least one said internet command function, including, but not limited to, hyper-linking, typed instructions, touch screen and voice commands, as well as go-to page commands, are recorded, through computer software system code and display therein said computer software system image interface, including, but not limited to, desktop window and menus, website browser and menus, toolbar and menus, or webpage contents window said computer software system predetermined or created code image record result or more simplified produced list;

The computer software system wherein computer cookie information, including various other data tracking systems, but not limited to this parameter, automatically determines destination through actuation command instructions therein stored said cookie or said data tracking system information wherein at least one criteria value within an organized database interface sets said computer software system conversion at least one record image, at least one sequential image or at least one within simplified produced lists;

The computer software method wherein the unified tracking in a database is a system in part and whole located locally on hard-drives and remotely on servers and through internet protocol at times on storage systems, such as, IP telephony, mobile phones, mobile system storage devices and average home and laptop computers used for software installations, and the offer of the present invention is to use a method within these internet systems and to provide at least one form of object to create trails of URLs that are readily edited, added, deleted, and shared;

The method wherein computer peripherals, either by button, touch screen, voice command, or other, are utilized by the computer user to provide in part or in whole the user's usage;

The method wherein an interface allows said user to type potential URL usage trails wherein actuations are automatic or manually used therein use said URLs typing said interface tool;

The computer software system wherein a computer user organizes, adds, edits, or deletes at least one image record, at least one sequential image or at least one within produced list wherein automated at least one criteria value within an organized database interface implementation is completed;

The computer software system wherein at least one image or said at least one sequential image or said at least one produced list potential path are selected having at least one criteria value within an organized database interface wherein at least one internet transfer said path delivers website expert component created advertising indicia therein said organized database interface wherein said advertising indicia appear thereon website content pages utilizing predetermined potential path embedded website code integrated by an expert website owner or affiliate;

The computer software system wherein automated data tracking simplified form said system code image, having at least one tracking record result, wherein organized, automated, at least one criteria value within an organized database interface, producing lists through user participation, displaying unique menus, including but not limited to, a mouse menu, or pull down menu therein computer software system interface wherein said menu use results advantageous computer usage said at least one record image, at least one sequential image, or said at least one within simplified produced lists;

The computer software system wherein a computer user saves at least one website wherein automated at least one criteria value, such as, computer saving within an organized database interface is set wherein record said website creates said at least one recorded image, said at least one sequential image or said at least one simplified produced list;

The computer software system wherein a computer user visits a website wherein automated at least one criteria value within an organized database interface is set wherein record most visited website is created said at least one recorded image or said at least one simplified produced list;

The computer software system wherein a computer user menu is opened wherein automated at least one criteria value within an organized database interface is set wherein record desktop window or website window is created said at least one recorded image or said at least one simplified produced list;

The computer software system wherein a computer user opens at least one desktop window or at least one website window wherein at least one criteria value within an organized database interface is set wherein multiple windows can be opened at one time wherein at least one record image, at least one sequential record image or at least one within simplified produced list opens at least one window;

The computer software system wherein a computer user opens at least one desktop window or at least one website window wherein at least one criteria value within an organized database interface is set wherein before, during, or after at least one record image, at least one sequential record image or at least one within simplified produced list recalls at least one closed window.

### BRIEF DESCRIPTION OF THE DRAWINGS

The present invention can best be understood in conjunction with the accompanying drawings, in which:

FIG. 1 is a flow diagram of URLs appended together by commands and saved in a database.

FIG. 2 is a flow diagram of URLs appended together by commands and saved in a database wherein a calculation is applied.

FIG. 3 is a two-dimensional drawing of a desktop application database interface.

FIG. 4 is a two-dimensional drawing of a more sophisticated application database interface.

FIG. 5 is a two-dimensional view of the internet and an “object” toolbar and similarly tab-system.

FIG. 6 is a two-dimensional view of the internet and a sophisticated “object” known as a website browser and side-bar.

### DETAILED DESCRIPTION OF THE INVENTION

It is well known that communicating about the internet is done by single URLs sent mostly via email to friends, customers, family, and the ordinary person, suggesting the most important of their findings of research in their results to these others as a result of browsing the internet, opening websites, and researching different items of interest that become accessible to others through an “email your friend an item campaign” by a website designer or copy and paste internet URL links in email to share information as well as saving for themselves the same information in a history within internet browsers.

In this invention, the unified tracking in a database is a system in part and whole located locally on hard-drives and servers and through internet protocol at times on storage systems, such as, IP telephony, mobile phones, mobile system storage devices and average home and laptop computers used for software installations, and the offer of the present invention is to use a method within these internet systems and to provide at least one form of object to create trails of URLs that are readily edited, added, deleted, and shared with the same properties for others receiving them to change them or to design their own, having primary URLs as a point to point or step by step to a landing page or pages.

It is also well known 'to developers and software engineers in a business environment that Microsoft Excel has two macro programming languages available to create applications and run a system of calculations on the database in the spreadsheet in a written command by command line. One of those programs at present is the Microsoft Excel version 4.0 macro language. And the other is Visual Basic, a long time program available for many years and continuously updated. Visual Basic language is nominated as the best because it is more flexible and powerful than the Microsoft Excel version 4.0 macro language. However, macros, sometimes mini-applications, can be found on the internet for a plurality of purposes. For example, the lay user's purpose is to type in the command lines of the macro program language, a series of written lines to enable highlighting duplicate entries in a long list of addresses. The user can then see in, red, the rows of the spreadsheet that indicate a duplicate in a spreadsheet of thousands of possible entries that would otherwise be unrecognizable and difficult on the human eye to find. And this is how programming works to enable a user a benefit.

It can also be further said from the previous example, you may want to write additional line commands to delete these duplicate entries and put in better and more likely candidates for a mailing, based on age, demographic, or updated information as it becomes available. This would utilize a business network through an IT professional, an environment where information is available on another person's hard-drive, server, or mobile application storage device therein containing the program language for recognition for finding better possibilities. This would be recognized as database management for a business interested in communicating and calculating data between one another where the Excel spreadsheet would be the computer image interface.

Microsoft Visual Studio Professional 2008, an available programming language, works within these principles, to allow for database engineers, to create an image interface both online and on the computer desktop. For example, the image interface software language, are typed as command lines as a part of the computer software program, commonly known to the database engineer or software developer. Tools are available for working with images. And the visual interface is created on a desktop or within an internet page, and can include additional visual objects thereon, such as, places for produced lists, menus, toolbars, browsers, website thumbnails of the present inventions trails to be used on the computer desktop screen or internet. The program can be tested by the written command by command line that can offer the user to implement actions and calculations on a database, within the software, and can readily be used for visual network on the internet on open access internet programs located on the computer desktop in software located on hard-drives on computers and laptops and other storage devices, such as, servers, IP telephony and mobile phones or on the internet. This is only an example of the step procedure and such a program allowing the same.

Keyboard and mice hardware with wireless or physical connections to the computer can be served as usable tracking systems by using the hardware, such as, memory buttons, tracking and recording the internet usage, or command buttons thereon, giving the actuation from one step to another.

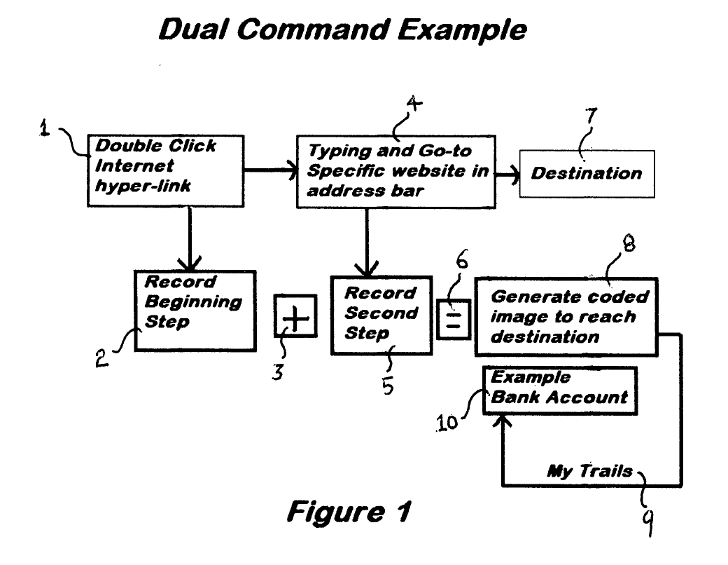

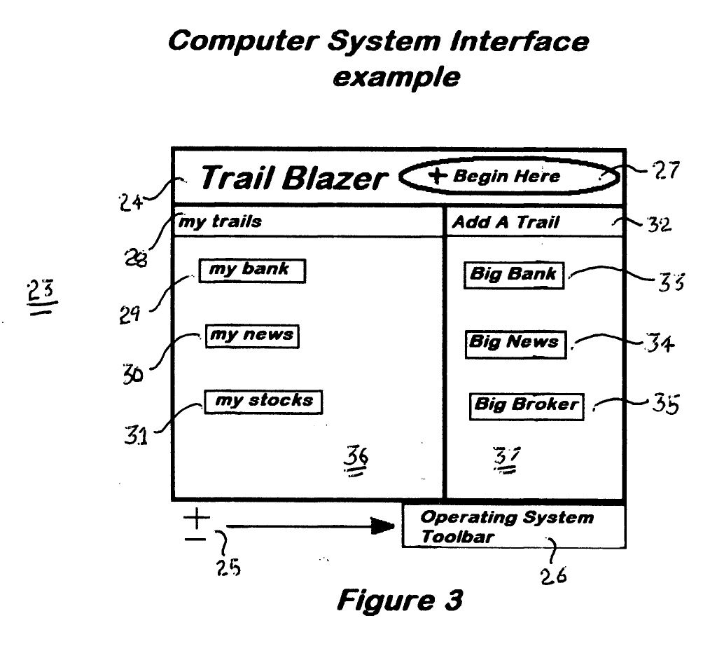

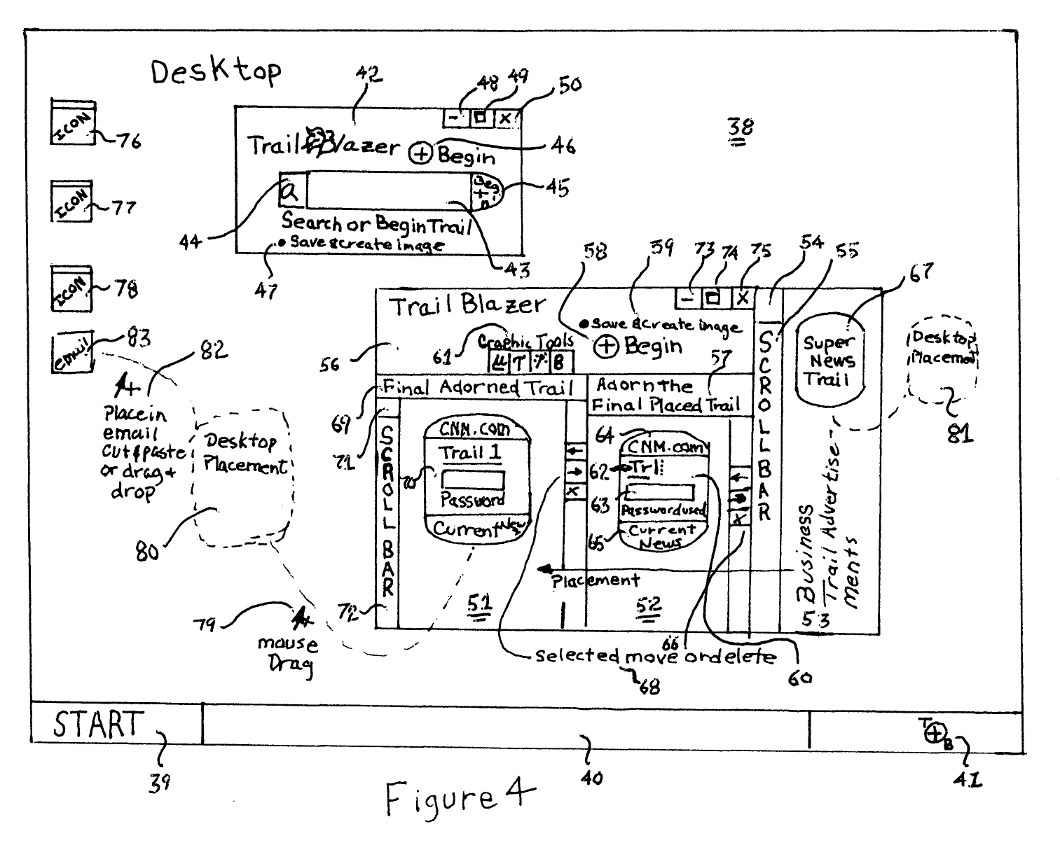

FIG. 1 shows a flow diagram and where someone uses a command to access the internet 1, the database records that step 2, adds another command 3 that is a go-to command 4, records and appends command 3 upon step 5 is saved 6 as in FIG. 4 number 47 or automatically and has destination 7 created as an object 8 located in a pane as in FIG. 3 my trails 28 as a bank account research 10, having password as in FIG. 4 number 63.

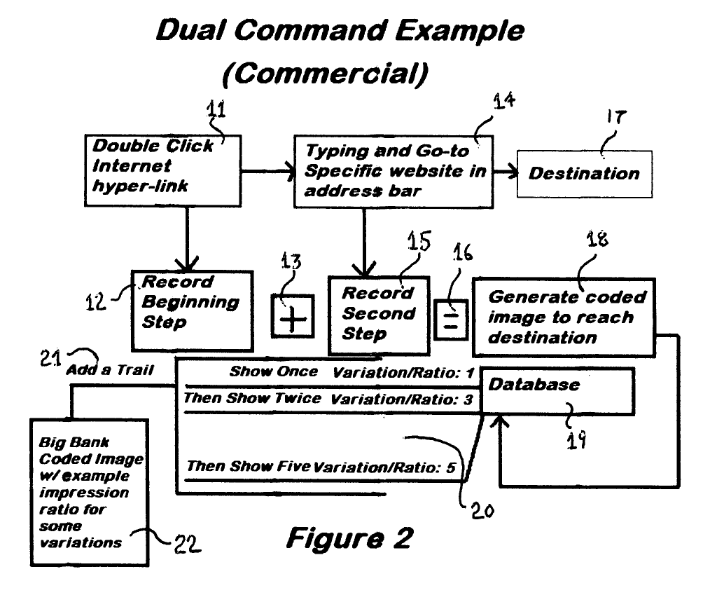

FIG. 2 shows a flow diagram and where a commercial trail is created through a command to access the internet 11, the database records that step 12, adds another command 13 that is a go-to command 14, records and appends command 13 upon step 15 is saved 16 as in FIG. 4 number 47 or automatically and has destination 17 created as an object 18 located in a database 19 has calculation within 20 is added for consumer 21 as in FIG. 3 add a trail 32 as a bank account company for consumer use 22.

FIG. 3 a computer screen 23 is shown with database interface 24 positively or negatively located 25 on an operating system toolbar or sidebar 26, having a beginning trail departing 27 to create my trails 28 my bank 29 my news 30 and my stocks 31 in pane 36 and add a trail from commercial users 32 big bank 33 big news 34 and big broker 35 located in pane 37.

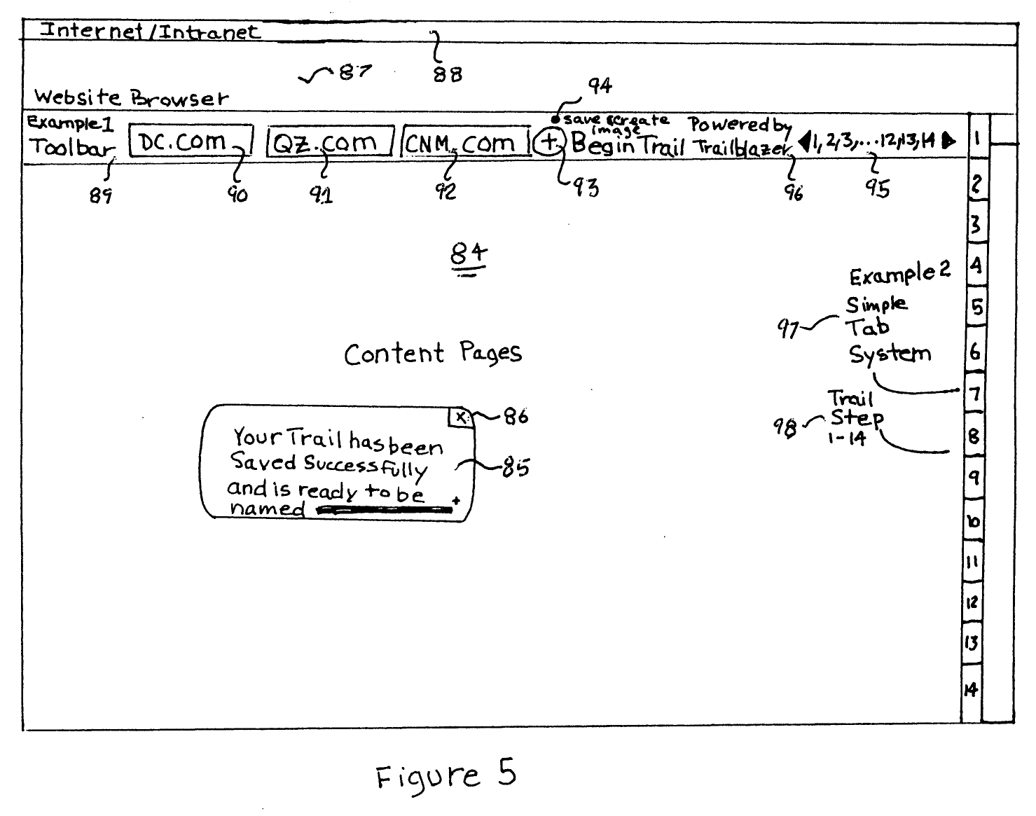

FIG. 4 a computer screen 38 shows operating system toolbar start button 39 operating system toolbar 40 and task tray installed software trail blazer 41 with screen also showing a mini interface 42 having a toolbar like search box 43 search button 44 and optional begin trail button 45 or 46 to be saved and created 47 or automatically as shown accomplished in FIG. 5 and successful 85 with also minimizing 48 fit in window 49 and closing system 50 and a similar system interface to FIG. 3 shows panes 51, 52, and 53 with scroll bar object 54, scroll bar 55 for business advertisement trails 67 placement table 66 directly to final adorned trail 69 as selected by consumer or placement table 68 moving adorned trail named 62 by graphic tool usage 61 and pre-placed advertisements 64 and 65 with password entry box 63 to final adorned trail 69 a complete trail desktop icon 70 and scroll bar object 71 used to scroll bar 72 down through items in pane 51 where the unit interface has minimizing tool 73 fit in window tool 74 and closing tool 75 where the desktop has icons 76, 77, and 78 that could be from a mouse dragging 79 adorned trail 70 to desktop placement 80 or business trail 81 and copying and pasting 82 into email drop 83.

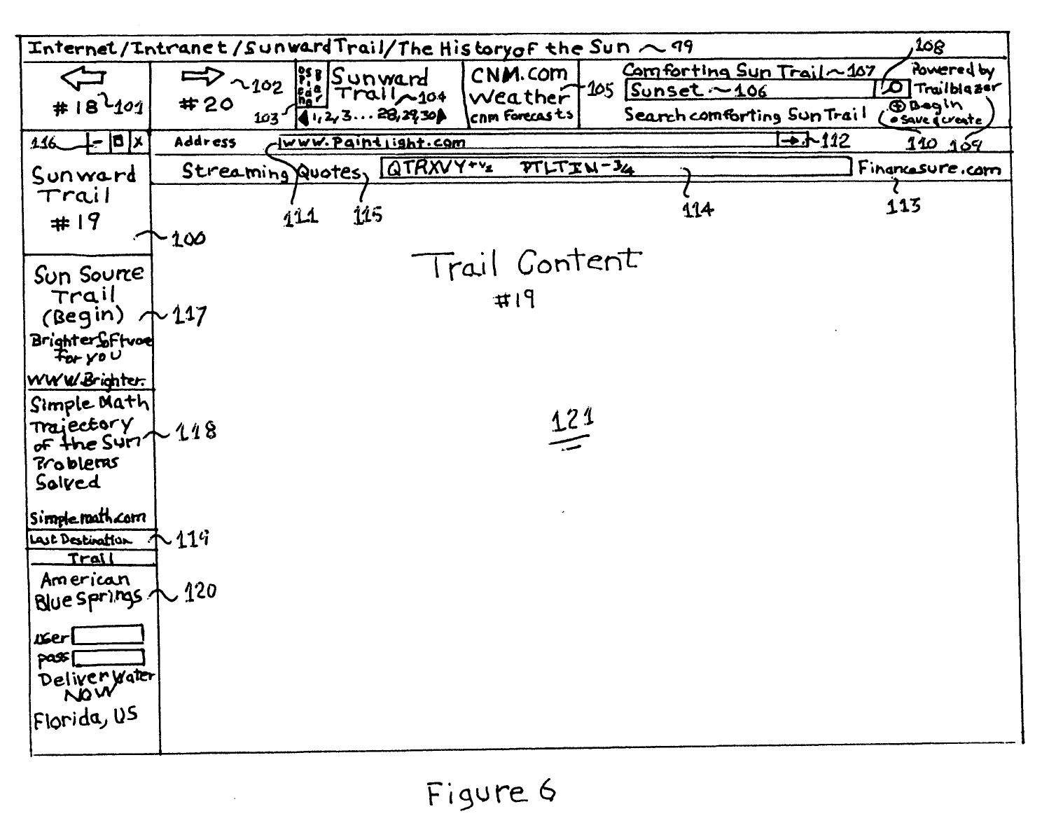

FIG. 5 shows an internet content page 84 that stores desktop icons as in FIG. 4 number 70 for a user to begin online and a trail that began 93 and saved 94 is successfully saved in the content page or a content page where database or integrated advertisements are used for the consumer in 84 or also separately showing in an automated system the desktop icon result, produced list, and successful manual save 85 and closing box 86 where the rest of the screen has a browser 87 on an internet or intranet 88 with toolbar object 89 included advertisements from the database 90, 91, and 92 with numbering of the entire trail displayed in 95 and market name 96 to become more apparent in FIG. 6 number 106 and finally tab systems displayed as another embodiment 97 and 98.

FIG. 6 shows the internet or intranet and title in 99 with a minimal unit box to be used to number trails 100 or unnecessary in some cases where the unit is one instead of nineteen and 101 shows the back to eighteen in the trail or forward to twenty of the trail in 102 to also close or open a sidebar in 103 the numbers in the trail 104 and targeted advertisements 105 and 118 related to weather and the sun and the keyword 106 in current trail 107 searching for other content in trails similar to 106 by pressing search in 108 and beginning trail and saving trails may be done in 109 and 110 including features to utilize an address in a new trail 111 and go-to in 112 therein also a website 113 and added streaming information 115 may also be used as a drop down menu separately 114 with a produced trail list where further a similar trail is advertised in 117 and the last destination of purchase is shown in 119 and 120 through the use of a previous trail and finally 121 display trail content for number nineteen in the set.

I claim:

1. A computer software system, having command method comprising multiple internet commands appended thereto, wherein the following instructions are utilized:
I.) A commercial or consumer computer user selects first internet command function, accessing the internet;
II.) Said commercial or consumer computer user selects the second internet hyper-linking command function, said command function, appending command function I, logging pathway I, and logging and actuating command thereon dependent function II, resulting dual command function, generated by computer software system;
III.) Said commercial or consumer computer user selects another command, creating triple command and further commands or stops;
IV.) A generated coded set of sequential images predetermined or created becomes said consumer computer user accessible or said commercial computer user database directed;
V.) Said consumer user said accessible said sequential images display said command functions in unitary sequence format wherein said computer user chooses step 1 said sequential image displaying step 2 upon selection said step 1;
VI.) Or said commercial computer user said database directed said sequential images display said command functions in unitary sequence format wherein said commercial computer user sets onto said database network;
Wherein said computer software system, including, but not limited to, provide said accessible said unitary or said sequential image said consumer user access within said computer interface, including, but not limited to, desktop or webpage said computer software system code image record result or said commercial computer said database directly through said computer software system image interface through placing sequential image data therein through internet said commercial computer user said consumer computer user personal locations, such as objects, but not limited to, toolbars, or browsers or within accessible webpage via said network, including, but not limited to, desktop or webpage said computer software system code image record result, including, not requiring, but not limited to, at least one advertising indicia.

2. The computer software system in claim 1 wherein at least one dual internet command function said sequential image is created, including, but not limited to, utilizing hyper-linking, typed instructions, go-to page commands, touch screen and voice control for continuing to access internet further displays.

3. The computer software system in claim 1 wherein networks or email are used sharing images or said sequential images.

4. The computer software system in claim 1 wherein an image or sequential image is predetermined or personally created.

5. The computer software system in claim 1 wherein said database uses multiple trail images variations ranking.

6. The computer software system in claim 1 wherein said database can be searched, but not limited to, keywords wherein said keywords are within said content or title another trail.

7. The computer software system in claim 1 wherein a separate system graphic interface, including, but not limited to, computer system interface tool bars, desktop icons, website browsers, or most recent graphics displayed in any format, are used to begin tracking, also displaying upon said image or said sequential image, within said separate system graphic interface, step values, in part or whole, ability to toggle forward or backward, or said images or said sequential images, having said value or said values, wherein displayed separately, within said separate system graphic interface, are the pertaining number of steps taken or said ability to toggle forward or backward and advertising indicia thereon said separate system graphic interface.

8. The computer software system in claim 1 wherein pre-designed website pages or computer interface images provide trail destinations containing at least one common command thereto, pertaining, but not limited to, tutorials, research workflows or presentations.

9. The computer software system in claim 1 wherein type or hyperlink color, but not limited to, colored boxing these, are used to follow destined trails said computer user providing at least one said actuation command either alternately between said image or said sequential image or utilizing completely.

10. The computer software system in claim 1 wherein computer cookie information determines destination through actuation command instructions upon stored said cookie information said computer software system conversion.

11. The computer software system in claim 1 wherein at least one image or at least one said sequential image having at least one adorned hyper-link advertising indicia.

12. The computer software system in claim 1 wherein at least one image or said at least one sequential image derives at least one related separate graphic interface, such as, but not limited to, internet and desktop toolbars, menus, or open interfaces, transforming, during a transition from the desktop to the internet, wherein at least one image or said at least one sequential image or their predecessor, at least one related separate graphic interface, advertise hyper-linked indicia.

13. The computer software system in claim 1 wherein at least one image, at least one said sequential image, or at least one related separate graphic interface, such as, but not limited to, internet and desktop toolbars, menus, or open interfaces has adorned hyper-link advertising indicia, wherein said advertising indicia is varied or has fixed multiple advertising exposures during each trail step.

14. The computer software system in claim 1 wherein at least one image or said at least one sequential image, includes, at least one type box, but is not limited to, internet searches, partial trail or end-result trail passwords and log-in name actuations, or streaming current advertising indicia.

15. The computer software system in claim 1 wherein at least one image is also available to drag and drop out of, and operate thereon, but is not limited to, the desktop, email, or a system network, still operated thereby said computer software system method or operated by computer software system method encoded therein at least one image or at least one said sequential image.

16. The computer software system in claim 1 wherein multivariate database tested said at least one advertising indicia wherein desktop or separate graphic system interface displays said at least one advertising indicia, resolving economic demand, including but not limited to, multiple advertising formats.

17. The computer software system in claim 1 wherein at least one said image or at least one sequential image is layered or said layer said image is encoded.

18. The computer software system in claim 1 wherein at least one image or said at least one sequential image potential path are selected having at least one criteria value within an organized database interface wherein at least one internet transfer said path delivers website expert component created advertising indicia therein said organized database interface wherein said advertising indicia appear thereon website content pages utilizing predetermined potential path embedded website code integrated by an expert owner said website.

19. A computer software system, having method comprising at least one internet command appended thereto record, wherein the following instructions are utilized:
I) An automated at least one criteria value within an organized database interface sets data tracking system selection before, during, or after computer user internet use;
II) The computer user selects at least one website;
III) A predetermined or personally created record results;
Wherein at least one said internet command function, including, but not limited to, hyper-linking, typed instructions, touch screen and voice commands, as well as go-to page commands, are recorded, through computer software system code and display therein said computer software system image interface, including, but not limited to, desktop window and menus, website browser and menus, toolbar and menus, or webpage contents window said computer software system predetermined or created code image record result or more simplified produced list.

20. The computer software system in claim 19 wherein computer cookie information, including various other data tracking systems, but not limited to this parameter, automatically determines destination through actuation command instructions therein stored said cookie or said data tracking system information wherein at least one criteria value within an organized database interface sets said computer software system conversion at least one record image, at least one sequential image or at least one within simplified produced lists.

21. The computer software method as in claim 1 wherein the unified tracking in a database is a system in part and whole located locally on hard-drives and remotely on servers and through internet protocol at times on storage systems, such as, IP telephony, mobile phones, mobile system storage devices and average home and laptop computers used for software installations, and the offer of the present invention is to use a method within these internet systems and to provide at least one form of object to create trails of URLs that are readily edited, added, deleted, and shared.

22. The method as in claim 1 wherein computer peripherals, either by button, touch screen, voice command, or other, are utilized by the computer user to provide in part or in whole the user's usage.

23. The method as in claim 1 wherein an interface allows said user to type potential URL usage trails wherein actuations are automatic or manually used therein use said URLs typing said interface tool.
